(19) United States
(12) Patent Application Publication
(10) Pub. No.: US 2025/0110784 A1
(43) Pub. Date: Apr. 3, 2025

(54) CACHING IN A MACHINE LEARNING MODEL HOSTING SERVICE

(71) Applicant: Amazon Technologies, Inc., Seattle, WA (US)

(72) Inventors: Deepti Laxman RAGHA, Sunnyvale, CA (US); Pratyush Kumar RANJAN, Arlington, VA (US); Michael PHAM, Seattle, WA (US); Maximiliano MACCANTI, Redmond, WA (US)

(21) Appl. No.: 18/478,185

(22) Filed: Sep. 29, 2023

(51) Int. Cl. G06F 9/50

(52) U.S. Cl. CPC G06F 9/5027; G06F 9/5077

(57) ABSTRACT

Techniques for caching in a machine learning model (ML) hosting service are described. ML model usage data is aggregated from host usage data provided from each host of a first set of hosts, the ML model usage data including, for a particular ML model, a number of inference requests to the particular ML model. A priority order of hosts in a second set of hosts to service an inference request for the particular ML model is calculated. Based on the ML model usage data and the priority order, a set of ML models to load to a particular host in the second set of hosts is determined. The particular host is caused to load the set of ML models. A router is updated to direct ML model inference requests amongst the second set of hosts.

### BACKGROUND

Machine learning (ML) refers to a discipline by which computer systems can be trained to perform a variety of tasks through repeated exposure to training data. The use of a trained model is often referred to as “inference,” during which the model receives new data that was not in its training data set and provides an output based on its learned parameters.

### BRIEF DESCRIPTION OF DRAWINGS

Various examples in accordance with the present disclosure will be described with reference to the following drawings.

FIG. 1 is a diagram illustrating an environment for hosting machine learning models in a cloud provider network according to some examples.

FIGS. 2A and 2B are diagrams illustrating a relationship between model loading and latency with and without cache pre-warming according to some examples.

FIG. 3 is a diagram illustrating a hashing technique to determine model host priority according to some examples.

FIG. 4 is a diagram illustrating cache pre-warming according to some examples.

FIG. 5 is a flow diagram illustrating operations of a method for caching in a machine learning model hosting service according to some examples.

FIG. 6 illustrates an example cloud provider network environment according to some examples.

FIG. 7 is a block diagram of an example cloud provider network that provides a storage service and a hardware virtualization service to customers according to some examples.

FIG. 8 is a block diagram illustrating an example computing device that can be used in some examples.

### DETAILED DESCRIPTION

The present disclosure relates to methods, apparatus, systems, and non-transitory computer-readable storage media for caching in a machine learning model (ML) hosting service. According to some examples, a group of cloud provider network hosts, sometimes referred to collectively as an endpoint, execute ML models to service inference requests. In a dynamic environment such as a cloud provider network environment network, various events may cause a change in the makeup of those hosts, such as adding new hosts to expand the group of hosts or to apply software updates. Introducing new hosts that have not serviced inference requests and thus have not loaded any models can result in, at least initially, a high cache miss rate (up to 100% if the entire set of hosts changes). That miss rate will slowly decrease over time as hosts load models from network storage to local storage and from local storage to execution environment memory, but misses nevertheless degrade the end-user experience during the model repopulation period due to the additional latency needed to load the requested models. Disclosed herein are techniques to mitigate and potentially eliminate these performance penalties by pre-loading models to hosts such that when a host is introduced, the host receives requests for models that are likely pre-loaded.

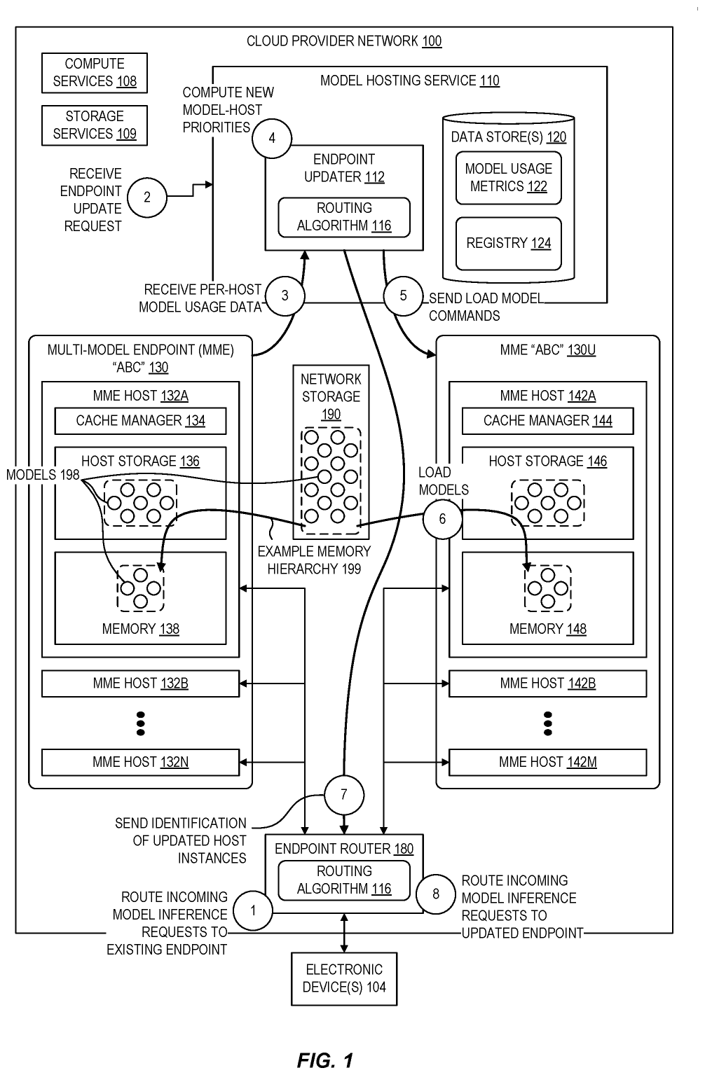

FIG. 1 is a diagram illustrating an environment for hosting machine learning models in a cloud provider network according to some examples. A model hosting service 110 of a cloud provider network can provide ML model hosting services. A cloud provider network 100 (also referred to herein as a provider network, service provider network, etc.) provides users with the ability to use one or more of a variety of types of computing-related resources such as compute resources (e.g., executing virtual machine (VM) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (CDNs), Domain Name Service (DNS)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users (or “customers”) of cloud provider networks 100 can use one or more user accounts that are associated with a customer account, though these terms can be used somewhat interchangeably depending upon the context of use. Cloud provider networks are sometimes “multi-tenant” as they can provide services to multiple different customers using the same physical computing infrastructure.

Users can interact with a cloud provider network 100 across one or more intermediate networks (e.g., the internet) via one or more interface(s), such as through use of application programming interface (API) calls, via a console implemented as a website or application, etc. An API refers to an interface and/or communication protocol between a client and a server, such that if the client makes a request in a predefined format, the client should receive a response in a specific format or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another. The interface(s) can be part of, or serve as a front-end to, a control plane of the cloud provider network 100 that includes “backend” services supporting and enabling the services that can be more directly offered to customers.

Thus, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

To provide these and other computing resource services, cloud provider networks 100 often rely upon virtualization techniques. For example, virtualization technologies can provide users the ability to control or use compute resources (e.g., a “compute instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code-typically without the user having any control of or knowledge of the underlying compute instance(s) involved.

As described herein, one type of service that a provider network may provide may be referred to as a “managed compute service” that executes code or provides computing resources for its users in a managed configuration. Examples of managed compute services include, for example, a hardware virtualization service, a container service, an on-demand code execution service, or the like. Such services are collectively represented as compute services 108.

A hardware virtualization service (referred to in various implementations as an elastic compute service, a virtual machines service, a computing cloud service, a compute engine, or a cloud compute service) can enable users of the cloud provider network 100 to provision and manage compute resources such as virtual machine instances. Virtual machine technology can use one physical server to run the equivalent of many servers (each of which is called a virtual machine), for example using a hypervisor, which can run at least partly on an offload card of the server (e.g., a card connected via PCI or PCIe to the physical CPUs) and other components of the virtualization host can be used for some virtualization management components. Such an offload card of the host can include one or more CPUs that are not available to user instances, but rather are dedicated to instance management tasks such as virtual machine management (e.g., a hypervisor), input/output virtualization to network-attached storage volumes, local migration management tasks, instance health monitoring, and the like). Virtual machines are commonly referred to as compute instances or simply “instances.” As used herein, provisioning a virtual compute instance generally includes reserving resources (e.g., computational and memory resources) of an underlying physical compute instance for the client (e.g., from a pool of available physical compute instances and other resources), installing or launching required software (e.g., an operating system), and making the virtual compute instance available to the client for performing tasks specified by the client.

A container service, such as a container orchestration and management service (referred to in various implementations as a container service, cloud container service, container engine, or container cloud service) allows users of the cloud provider network to instantiate and manage containers. In some examples the container service can be a Kubernetes-based container orchestration and management service (referred to in various implementations as a container service for Kubernetes, Azure Kubernetes service, IBM cloud Kubernetes service, Kubernetes engine, or container engine for Kubernetes). A container, as referred to herein, packages up code and all its dependencies so an application (also referred to as a task, pod, or cluster in various container services) can run quickly and reliably from one computing environment to another. A container image is a standalone, executable package of software that includes everything needed to run an application process: code, runtime, system tools, system libraries and settings. Container images become containers at runtime. Containers are thus an abstraction of the application layer (meaning that each container simulates a different software application process). Though each container runs isolated processes, multiple containers can share a common operating system, for example by being launched within the same virtual machine. In contrast, virtual machines are an abstraction of the hardware layer (meaning that each virtual machine simulates a physical machine that can run software). While multiple virtual machines can run on one physical machine, each virtual machine typically has its own copy of an operating system, as well as the applications and their related files, libraries, and dependencies. Some containers can be run on instances that are running a container agent, and some containers can be run on bare-metal servers, or on an offload card of a server.

Another type of managed compute service can be an on-demand code execution service (referred to in various examples as a function compute service, functions service, cloud functions service, functions as a service, or serverless computing service) that can enable users of the cloud provider network 100 to execute their code on cloud resources without having to select or manage the underlying hardware resources used to execute the code. For example, a user can use an on-demand code execution service by uploading their code and use one or more APIs to request that the service identify, provision, and manage any resources required to run the code. Thus, in various examples, a “serverless” function can include code provided by a user or other entity—such as the provider network itself—that can be executed on demand. Serverless functions can be maintained within the provider network by an on-demand code execution service and can be associated with a particular user or account or can be generally accessible to multiple users/accounts. A serverless function can be associated with a Uniform Resource Locator (URL), Uniform Resource Identifier (URI), or other reference, which can be used to invoke the serverless function. A serverless function can be executed by a compute resource, such as a virtual machine, container, etc., when triggered or invoked. In some examples, a serverless function can be invoked through an application programming interface (API) call or a specially formatted HyperText Transport Protocol (HTTP) request message. Accordingly, users can define serverless functions that can be executed on demand, without requiring the user to maintain dedicated infrastructure to execute the serverless function. Instead, the serverless functions can be executed on demand using resources maintained by the cloud provider network 100. In some examples, these resources can be maintained in a “ready” state (e.g., having a pre-initialized runtime environment configured to execute the serverless functions), allowing the serverless functions to be executed in near real-time.

The cloud provider network 100 can also offer data storage via storage services 109 such as block storage service and object storage services. Block storage services can provide virtualized volumes that can be attached to or otherwise accessed by computing resources provisioned by compute services 108. For example, one instance might have an attached volume with a storage allocation of tens or hundreds of gigabytes within which applications executed by the instance are able to read and write files within a directory structure. Object storage services store objects (including files) typically within a data structure such as a key-value store and often without a fixed storage allocation. Other storage services 109 can include databases and the like.

One type of service that the model hosting service 110 can provide is a multi-model endpoint (MME). An MME provides end-users with access to multiple ML models. MMEs are typically structured in a distributed manner, allowing the MME to service multiple concurrent ML model inference requests (including to the same ML model). An example MME 130 having an identifier “ABC” is shown. MMEs may be considered part of the model hosting service 110. The MME 130 includes some number of hosts 132A-132N, which may be variously referred to as a group, fleet, or generally as a set. Hosts 132 are typically virtualized as virtual machines, containers, or the like, on top of cloud provider network infrastructure. An example host 132A includes a cache manager 134 application and host storage 136 (e.g., disk/flash). In this example, models are executed within a virtualized environment of the host (e.g., a container) having memory 138. (Note that hosts may have multiple model-hosting environments. For example, host 132A might other environments with different model memories to execute models of MMEs of different customers.)

Storage services 109 can provide a network storage repository (or just “network storage”) 190 for models 198. The network storage 190 may be considered part of the model hosting service 110. Network storage 190, host storage 136, and memory 138 form an exemplary memory hierarchy 199. Given a large enough number of models, each host can only load a smaller subset of the total number of models into host storage 136, and an even smaller subset of models into memory 138 to perform inference tasks. If a host 132 receives a request to perform an inference operation with a model not loaded into memory 138, the cache manager 134 can load the model from host storage 136 to memory 138 (and evict another model to free room, if needed). If the model is not present in host storage 136, the cache manager 134 can fetch the model from the network storage 190. Operations to load a model from network storage to host storage and/or from local storage to memory have a latency penalty. Servicing a request targeting a model loaded in memory is faster than one targeting a model that a host needs to load from local storage which in turn is faster than targeting one a host needs to load from network storage.

The model hosting service 110 includes data store(s) 120, which may be backed by storage services 109. The model hosting service 110 can maintain a registry 124 of MMEs and associated hosts. For example, an entry for MME “ABC” can have an associated set of host identifiers that identify each of its associated hosts. Host identifiers may be resource identifiers, network addresses, or the like. Each host may have an associated status indicator. An exemplary set of status indicators includes “active,” (to indicate the host is servicing inference requests), “new” (to indicate hosts to be added to the set of hosts servicing inference requests) and “terminate” (to indicate hosts to be removed from the set of hosts servicing inference requests).

In FIG. 1, the circles labeled (1)-(8) illustrate an example process in which new hosts with pre-loaded models are introduced to an MME. Note that during this process, the identity of the MME 130 from the perspective of a customer (e.g., MME “ABC”) can persist after introducing hosts 142. Initially, as indicated at circle (1), an endpoint router 180 routes inbound model inference requests to a set of hosts forming the MME 130. Examples of endpoint router 180 include network devices, network appliances, or software-based networking applications executed by compute services 108, etc. In some examples, the endpoint router 180 is formed of multiple independent nodes. The endpoint router 180 may be considered part of the model hosting service 110.

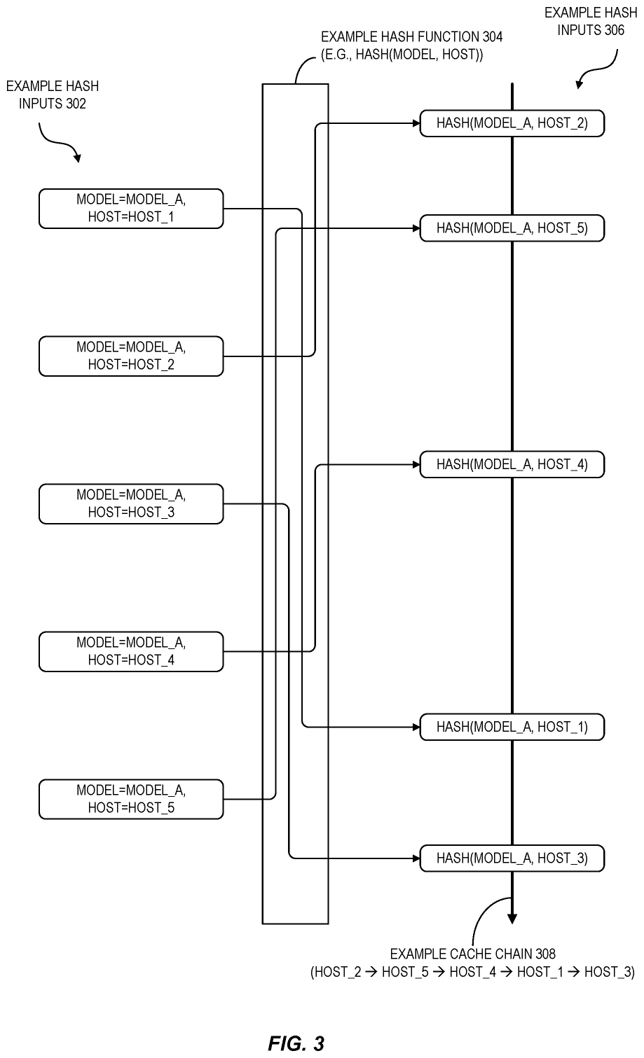

The endpoint router 180 (or a node thereof) calculates, using a routing algorithm 116, which host to direct an inbound model inference request to. An example routing algorithm follows. The routing algorithm 116 may compute a priority order of hosts to service requests using a hash function. The hash function can take, as input, a combination of a model identifier included in the request and each of the “active” host identifiers, such as their network addresses. The algorithm 116 can use a numeric ordering (e.g., lowest to highest) of those hash function outputs as the priority order for determining where to route the request. An example of this routing strategy is illustrated in FIG. 3. The endpoint router 180 can proceed to route requests to hoses in that order based on the volume of inbound requests to that model.

For example, when a request comes in for a particular, the endpoint router 180 that received the request can start a timer (e.g., a two-minute timer). If the router sees more than X requests for that model within the two-minute timer, it will begin routing to the second host in the order (e.g., X=5). If it sees another X requests, it will begin routing to the third host in the order, and so on. When the timer expires, that router will resume routing requests to the first host in the order (and start a new timer).

In this manner, the endpoint router 180 routes requests for a particular model to the same hosts in the same order. As a byproduct, a host such as host 132A is more likely to be able to persist models for which the endpoint router 180 prioritizes host 132A in in memory 138 (or, if not, in host storage 136). In this manner, certain models are “stickier” (or have an affinity) to certain hosts. The per-model host ordering is referred to herein as a “cache chain.”

As indicated at circle (2), the model hosting service 110 receives an MME update request, which, as described above, can be used to update software of an MME or can be used to change the configuration of hosts of the endpoint (e.g., to add or remove hosts). The request may originate from an administrator of the cloud provider network 100, as part of automated maintenance operations, as directed by a customer, etc. In this example, the request can be to update the MME ABC, the update including adding hosts, which the model hosting service 110 has launched as a set of hosts 142A-M to be added to the MME 130. The hosts 142A-142M can have associated “new” status identifiers in registry 124. An endpoint updater 112 application of the model hosting service 110 can manage the process of updating an MME.

At circle (3), an endpoint updater 112 receives per-host model usage data. In some examples, the cache managers of the hosts 132 send the per-host model usage data in response to a request or as part of a periodic usage report to the model hosting service 110. The usage data can be stored along with other calculated usage data in model usage metrics 122 of the data store(s) 120.

In some examples, the cache manager can vend an API that returns usage data. An exemplary API includes a listAllModels( ) call that exposes which models are loaded into model execution environment memory (e.g., memory 138 of host 132A) and, optionally, host storage (e.g., host storage 136 of host 132A). The usage data can further include usage data such as a “call count” or number of times that the model was called within the last time period (e.g., 60 minutes). The usage data can further include a “last access” time indicator such as a timestamp indicating when the model was last accessed. The last access time can augment the call count data to account for periodic but spikey traffic (e.g., models that are used more frequently than some models but outside of the call count time window.

At circle (4), the endpoint updater 112 calculates a cache chain for a new set of hosts that will serve model inference requests in the updated MME ABC. For example, the endpoint updater 112 can use the above described hash function to calculate a cache chain for each combination of a model in the set of models identified in the usage data and each host associated with the MME ABC having either an “active” or “new” status identifier (omitting any including the “terminate” identifier to be phased out).

The endpoint updater 112 can aggregate the model usage data across all of the hosts 132 to determine each model's individual popularity. For example, the endpoint updater 112 can sum the call count of each model to determine the total number of times the model was access across all of the hosts 132.

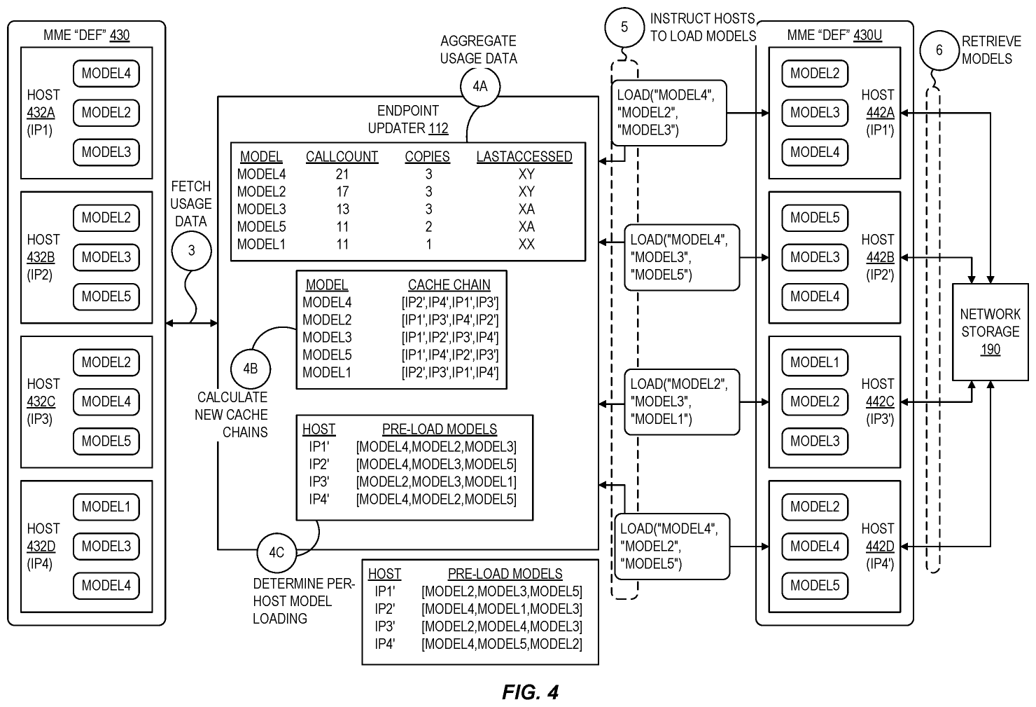

Using the cache chain and aggregated usage data, the endpoint updater 112 can identify models to pre-load onto the hosts 142. In some examples, the models to pre-load may include an identification of a first set of models to be loaded into host storage and execution environment memory (e.g., memory 148 of host 142A) and a second set of lower priority models to be loaded into host storage (e.g., host storage 146 of host 142A). Additional details of the calculation of the hash chain and model pre-loading selection are provided with reference to FIGS. 3 and 4.

At circle (5), the endpoint updater 112 instructs each of the cache managers of the hosts 142 (e.g., the cache manager 144 of host 142A) to load one or more models. For example, the cache managers can vend a loadModelAtContainer( ) call having a parameter identifying one or more models that, when called, causes of the cache manager to load the models identified in the set from network storage 190 to host storage and to execution environment memory. In some examples, the cache managers can vend a loadModelInStorage( ) call having a parameter identifying one or more models that, when called, causes of the cache manager to load the identified models identified in the set from network storage 190 to host storage. Given that both the amount of memory of execution environments and model sizes can vary, the pre-caching operations can result with hosts having different numbers of loaded models.

At circle (6), the cache managers of the hosts 142 carry out the load operations, loading the identified models into host storage and/or execution environment memory. In some examples, once the loading operations are complete, the cache manager of a host 142 can return an indication as such to the endpoint updater 112. Once the endpoint updater 112 receives that indication from each of the cache managers, the process can continue to circle (7). In other examples, the endpoint updater 112 can occasionally query the cache managers to check the state of the loaded models. Once the loaded model state matches the requested model state across the hosts 142, the process can continue to circle (7).

At circle (7), the endpoint updater 112 can update the “new” status of the hosts 142 to “active” in the registry 124 and send the host identifiers of each of the active hosts to the endpoint router 180.

At circle (8), the endpoint router 180 continues routing model inference requests amongst the updated set of hosts using the routing algorithm 116 described above. With the cache chain calculations performed by the endpoint updater 112 matching the host priority order of the endpoint router 180, the endpoint router 180 directs requests for a given model to those hosts more likely to have had that model pre-loaded.

Note that in some examples, one or more of hosts 132A-132N may still be included as part of the MME 130U, in such a case, the calculation of the cache chain can include the identifiers of the hosts 132 and 142 that will continue to service inference requests. In other examples, the switchover from hosts 132 to hosts 142 may be part of a blue-green deployment model in which the hosts 132 stop servicing inference requests when the hosts 142 are introduced (e.g., the router no longer routes requests to be serviced by hosts 132).

Compute services 108 can provide the compute backing for the illustrated components including the model hosting service 110, endpoint updater 112, MME 130/130U, hosts 132, 142, and endpoint router 180 (e.g., such components can be executed using resources provisioned by a hardware virtualization service, an on-demand code execution service, a container service, etc.).

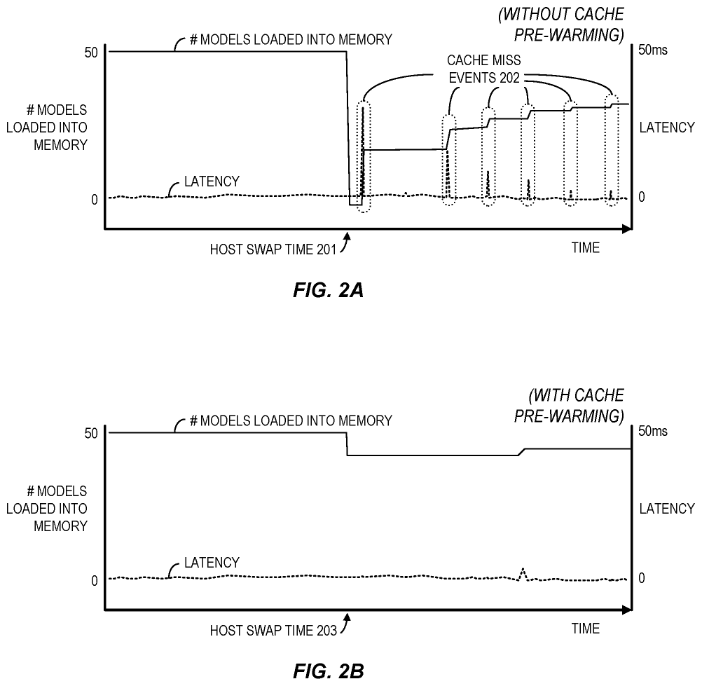

FIGS. 2A and 2B are diagrams illustrating a relationship between model loading and latency with and without cache pre-warming according to some examples. As indicated, FIG. 2A illustrates the performance penalty associated with introducing hosts without pre-warmed caches according to some examples. In particular, the number of models loaded to an MME (solid line, left vertical axis) the MME latency (dashed line, right vertical axis) plotted against time. As indicated by the cache miss events 202, when the underlying hosts of an MME are swapped at time 201 without pre-warming, the number of loaded models drops to zero, and there are performance penalties incurred each time a model is loaded. FIG. 2B illustrates the same plot but with data taken in a scenario where the hosts were introduced with cache pre-warming. As shown, the performance penalty associated with the host swap at time 203 is dramatically reduced (if not altogether eliminated).

FIG. 3 is a diagram illustrating a hashing technique to determine model host priority according to some examples. In this example, a hash function 304 is used to calculate a priority order amongst five hosts (HOST_1 . . . . HOST_5) for a given model (MODEL_A). The hash function takes as inputs a host identifier and model identifier. The host identifier may be a network address or other identifier that identifies the host within the MME. The model identifier may be a file name (e.g., “model_a.tar.gz”) or other identifier that identifies the model loaded to the MME. The host and model identifiers may be concatenated to form the hash function input. The example hash function inputs 302 include, for the model, the model and each of the hosts. The has function outputs 306 are indicated. Within the hash space, the ordered outputs for the hosts result in a cache chain 308 (the hash output for HOST_2 is at the start, followed, in order, by HOST_5, HOST_4, HOST_1, and HOST_3). Using a hash function in this manner allows independent routers to each direct inference requests to those hosts that are more likely to have the requested model loaded.

FIG. 4 is a diagram illustrating cache pre-warming according to some examples. In particular, the operations at circles (3) through (6) of FIG. 1 are further described with reference to a more particular example. Here, an MME 430 having identifier “DEF” originally including four hosts 432A-432D is being updated to hosts 442A-442D (with identifiers such as network addresses of IP1′, IP2′, IP3′, and IP4′, respectively). As noted above, the number of models that can be loaded to a particular host will vary given that model execution environments may have varying amounts of memory and models can vary in size. To keep the example simple, each host has a memory that can store three models, with the currently loaded models illustrated (e.g., host 432A has models 4, 2, and 3 loaded).

At circle (3), the endpoint updater 112 obtains usage data from each of the hosts 432. Here, host 432A sends usage data identifying models 2, 3, and 4; host 432B sends usage data identifying models 2, 3, and 5, and so on. Each host can also send the time that a given model was last accessed.

At circle (4A), the endpoint updater aggregates the received usage data to form per-model usage data for MME “DEF.” Here, model 4 was called 21 times within the time period, was reported as present on three hosts, and was most recently accessed at some time “XY;” while model 1 was called 11 times within the time period, was reported as loaded on one host, and was most recently accessed at some time “XX.”

At circle (4B), the endpoint updater 112 calculates the new host priority order or cache chain for the models. Using the hashing strategy of FIG. 3, for example, the endpoint updater 112 can determine the ordering of hash function outputs for model 1 and the identifiers of hosts 442 (e.g., IP1′, IP2′, IP3′, and IP4′), repeating the calculation for models 2 through 5. Exemplary cache chains are shown (e.g., the cache chain for model 5 is IP1′>IP4′>IP2′->IP3′).

At circle (4C), the endpoint updater 112 determines one or more models to load to each of the hosts 442. Various strategies can be used to place the models based on the per-model usage data and the cache chains. In some examples, models can be placed such that the number of copies of the highest priority model (here, model4 with 21 calls and 3 copies) are assigned prior to assigning the number of copies for the next priority model (here, model2 with 17 calls and 3 copies). The result of this greedy approach is illustrated (model 4 is assigned to IP1′, IP2′ and IP4′, the first three hosts in its cache chain; model 2 is assigned to IP1′, IP3′, and IP4′, the first three hosts in its cache chain; and so on).

In other examples, the endpoint updater 112 can use a round robin approach, where, beginning with the highest priority model, one copy of each model is placed in priority order into the next available host slot before restarting the assignment (up to the number of copies for the model). Under such an approach, model 4 would be assigned to IP2′ as the first host in its cache chain, models 2, 3, and 5 would be assigned in order to IP1′ (with IP1′ being the first host in their respective cache chains), and model 1 would be assigned to IP2′. Returning to model 4, it would be assigned to IP4′ as the next host in its cache chain, and so on.

In further examples, the endpoint updater 112 can distribute an equal number of model copies across the hosts independent of the number of copies present across the original MME, filling any remaining space with the higher priority models. Those of skill in the art will appreciate that other approaches are possible.

At circle 5, the endpoint updater 112 instructs each of the hosts 442 (e.g., a cache manager) to load the determined models (e.g., models 4, 2, and 3 for IP1′). At circle 6, the hosts load their respective models from network storage 190. With the models pre-loaded, the router can be updated to change the hosts associated with MME “DEF” from IP1, IP2, IP3, and IP4 to IP1′, IP2′, IP3′, and IP4′.

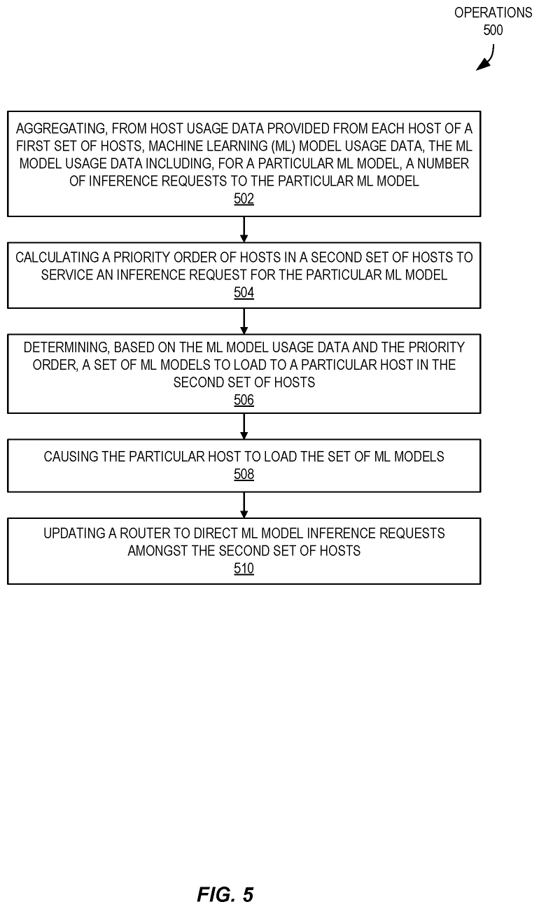

FIG. 5 is a flow diagram illustrating operations 500 of a method for caching in a machine learning model hosting service according to some examples. Some or all of the operations 500 (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations 500 are performed by endpoint updater 112 of the model hosting service 110 of the other figures.

The operations 500 include, at block 502, aggregating, from host usage data provided from each host of a first set of hosts, machine learning (ML) model usage data, the ML model usage data including, for a particular ML model, a number of inference requests to the particular ML model. The operations 500 further include, at block 504, calculating a priority order of hosts in a second set of hosts to service an inference request for the particular ML model. The operations 500 further include, at block 506, determining, based on the ML model usage data and the priority order, a set of ML models to load to a particular host in the second set of hosts. The operations 500 further include, at block 508, causing the particular host to load the set of ML models. The operations 500 further include, at block 510, updating a router to direct ML model inference requests amongst the second set of hosts.

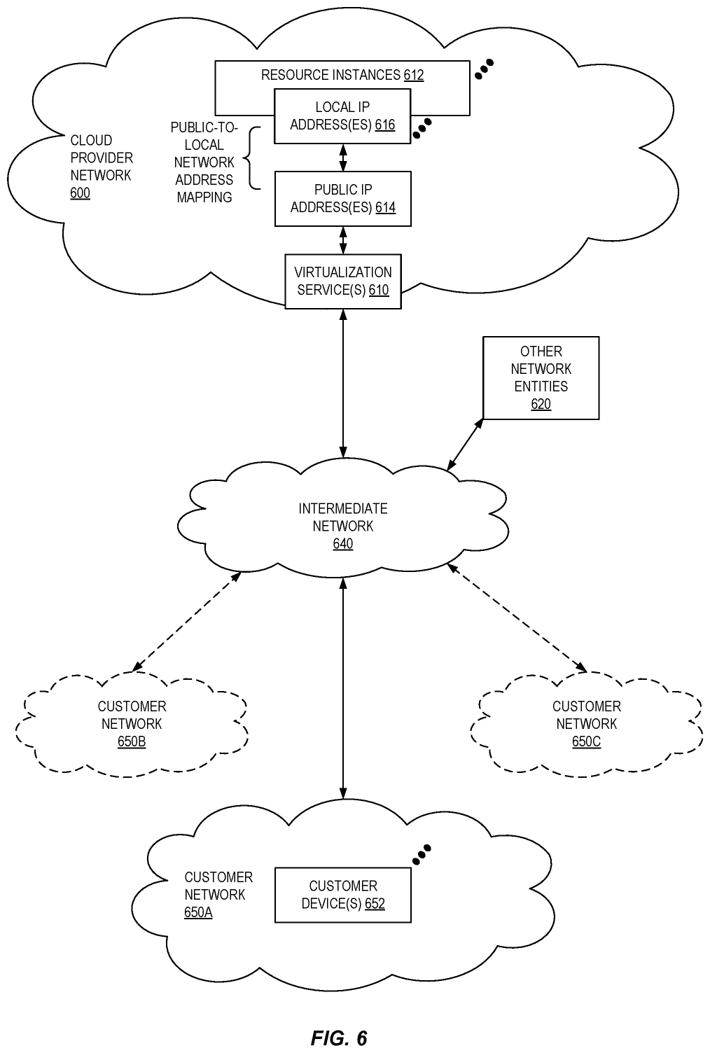

FIG. 6 illustrates an example provider network (or “service provider system”) environment according to some examples. A provider network 600 can provide resource virtualization to customers via one or more virtualization services 610 that allow customers to purchase, rent, or otherwise obtain instances 612 of virtualized resources, including but not limited to computation and storage resources, implemented on devices within the provider network or networks in one or more data centers. Local Internet Protocol (IP) addresses 616 can be associated with the resource instances 612; the local IP addresses are the internal network addresses of the resource instances 612 on the provider network 600. In some examples, the provider network 600 can also provide public IP addresses 614 and/or public IP address ranges (e.g., Internet Protocol version 4 (IPv4) or Internet Protocol version 6 (IPv6) addresses) that customers can obtain from the provider 600.

Conventionally, the provider network 600, via the virtualization services 610, can allow a customer of the service provider (e.g., a customer that operates one or more customer networks 650A-650C (or “client networks”) including one or more customer device(s) 652) to dynamically associate at least some public IP addresses 614 assigned or allocated to the customer with particular resource instances 612 assigned to the customer. The provider network 600 can also allow the customer to remap a public IP address 614, previously mapped to one virtualized computing resource instance 612 allocated to the customer, to another virtualized computing resource instance 612 that is also allocated to the customer. Using the virtualized computing resource instances 612 and public IP addresses 614 provided by the service provider, a customer of the service provider such as the operator of the customer network(s) 650A-650C can, for example, implement customer-specific applications and present the customer's applications on an intermediate network 640, such as the Internet. Other network entities 620 on the intermediate network 640 can then generate traffic to a destination public IP address 614 published by the customer network(s) 650A-650C; the traffic is routed to the service provider data center, and at the data center is routed, via a network substrate, to the local IP address 616 of the virtualized computing resource instance 612 currently mapped to the destination public IP address 614. Similarly, response traffic from the virtualized computing resource instance 612 can be routed via the network substrate back onto the intermediate network 640 to the source entity 620.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 600; a customer can then assign their allocated public IP addresses to particular resource instances allocated to the customer. These public IP addresses can be referred to as customer public IP addresses, or simply customer IP addresses. Instead of being assigned by the provider network 600 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

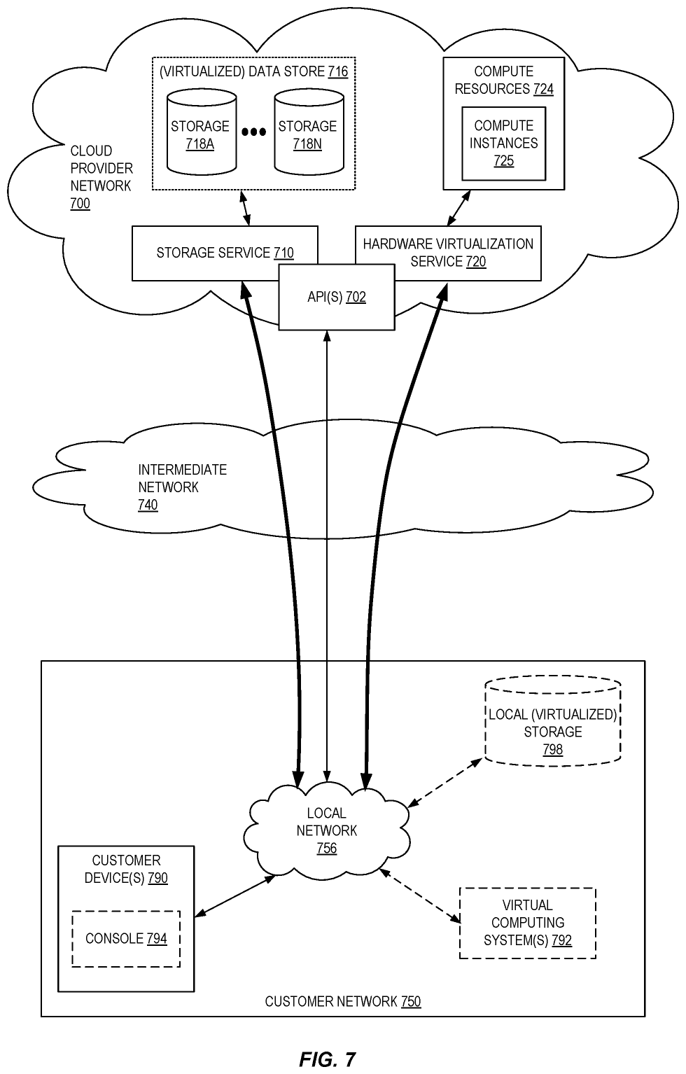

FIG. 7 is a block diagram of an example provider network environment that provides a storage service and a hardware virtualization service to customers, according to some examples. A hardware virtualization service 720 provides multiple compute resources 724 (e.g., compute instances 725, such as VMs) to customers. The compute resources 724 can, for example, be provided as a service to customers of a provider network 700 (e.g., to a customer that implements a customer network 750). Each computation resource 724 can be provided with one or more local IP addresses. The provider network 700 can be configured to route packets from the local IP addresses of the compute resources 724 to public Internet destinations, and from public Internet sources to the local IP addresses of the compute resources 724.

The provider network 700 can provide the customer network 750, for example coupled to an intermediate network 740 via a local network 756, the ability to implement virtual computing systems 792 via the hardware virtualization service 720 coupled to the intermediate network 740 and to the provider network 700. In some examples, the hardware virtualization service 720 can provide one or more APIs 702, for example a web services interface, via which the customer network 750 can access functionality provided by the hardware virtualization service 720, for example via a console 794 (e.g., a web-based application, standalone application, mobile application, etc.) of a customer device 790. In some examples, at the provider network 700, each virtual computing system 792 at the customer network 750 can correspond to a computation resource 724 that is leased, rented, or otherwise provided to the customer network 750.

From an instance of the virtual computing system(s) 792 and/or another customer device 790 (e.g., via console 794), the customer can access the functionality of a storage service 710, for example via the one or more APIs 702, to access data from and store data to storage resources 718A-718N of a virtual data store 716 (e.g., a folder or “bucket,” a virtualized volume, a database, etc.) provided by the provider network 700. In some examples, a virtualized data store gateway (not shown) can be provided at the customer network 750 that can locally cache at least some data, for example frequently accessed or critical data, and that can communicate with the storage service 710 via one or more communications channels to upload new or modified data from a local cache so that the primary store of data (the virtualized data store 716) is maintained. In some examples, a user, via the virtual computing system 792 and/or another customer device 790, can mount and access virtual data store 716 volumes via the storage service 710 acting as a storage virtualization service, and these volumes can appear to the user as local (virtualized) storage 798.

While not shown in FIG. 7, the virtualization service(s) can also be accessed from resource instances within the provider network 700 via the API(s) 702. For example, a customer, appliance service provider, or other entity can access a virtualization service from within a respective virtual network on the provider network 700 via the API(s) 702 to request allocation of one or more resource instances within the virtual network or within another virtual network.

### Illustrative Systems

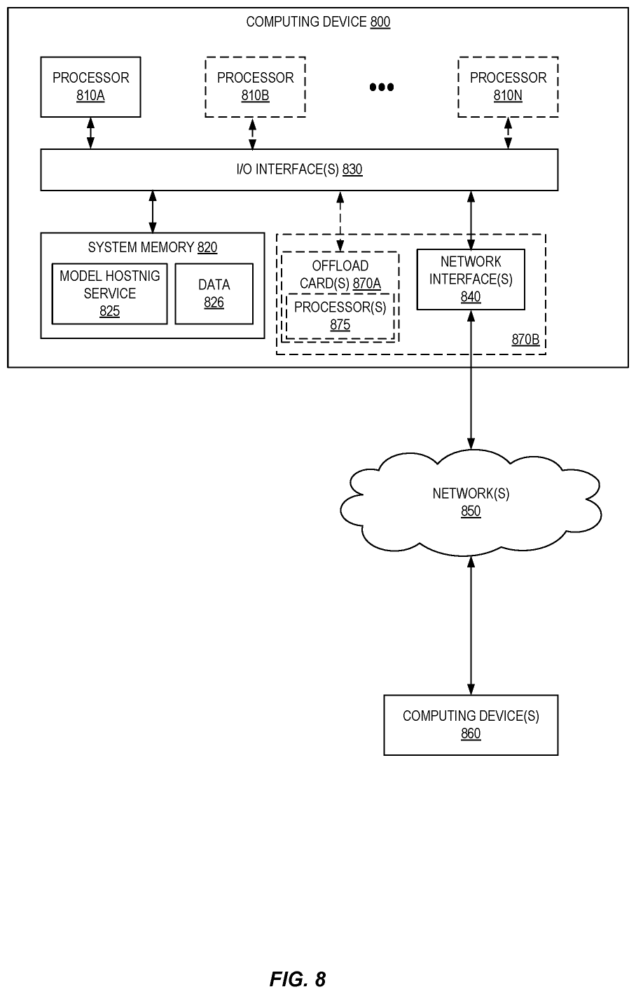

In some examples, a system that implements a portion or all of the techniques described herein can include a general-purpose computer system, such as the computing device 800 (also referred to as a computing system or electronic device) illustrated in FIG. 8, that includes, or is configured to access, one or more computer-accessible media. In the illustrated example, the computing device 800 includes one or more processors 810 coupled to a system memory 820 via an input/output (I/O) interface 830. The computing device 800 further includes a network interface 840 coupled to the I/O interface 830. While FIG. 8 shows the computing device 800 as a single computing device, in various examples the computing device 800 can include one computing device or any number of computing devices configured to work together as a single computing device 800.

In various examples, the computing device 800 can be a uniprocessor system including one processor 810, or a multiprocessor system including several processors 810 (e.g., two, four, eight, or another suitable number). The processor(s) 810 can be any suitable processor(s) capable of executing instructions. For example, in various examples, the processor(s) 810 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 810 can commonly, but not necessarily, implement the same ISA.

The system memory 820 can store instructions and data accessible by the processor(s) 810. In various examples, the system memory 820 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 820 as model hosting service code 825 (e.g., executable to implement, in whole or in part, the model hosting service 110) and data 826.

In some examples, the I/O interface 830 can be configured to coordinate I/O traffic between the processor 810, the system memory 820, and any peripheral devices in the device, including the network interface 840 and/or other peripheral interfaces (not shown). In some examples, the I/O interface 830 can perform any necessary protocol, timing, or other data transformations to convert data signals from one component (e.g., the system memory 820) into a format suitable for use by another component (e.g., the processor 810). In some examples, the I/O interface 830 can include support for devices attached through various types of peripheral buses, such as a variant of the Peripheral Component Interconnect (PCI) bus standard or the Universal Serial Bus (USB) standard, for example. In some examples, the function of the I/O interface 830 can be split into two or more separate components, such as a north bridge and a south bridge, for example. Also, in some examples, some or all of the functionality of the I/O interface 830, such as an interface to the system memory 820, can be incorporated directly into the processor 810.

The network interface 840 can be configured to allow data to be exchanged between the computing device 800 and other computing devices 860 attached to a network or networks 850, such as other computer systems or devices as illustrated in FIG. 1, for example. In various examples, the network interface 840 can support communication via any suitable wired or wireless general data networks, such as types of Ethernet network, for example. Additionally, the network interface 840 can support communication via telecommunications/telephony networks, such as analog voice networks or digital fiber communications networks, via storage area networks (SANs), such as Fibre Channel SANs, and/or via any other suitable type of network and/or protocol.

In some examples, the computing device 800 includes one or more offload cards 870A or 870B (including one or more processors 875, and possibly including the one or more network interfaces 840) that are connected using the I/O interface 830 (e.g., a bus implementing a version of the Peripheral Component Interconnect-Express (PCI-E) standard, or another interconnect such as a QuickPath interconnect (QPI) or UltraPath interconnect (UPI)). For example, in some examples the computing device 800 can act as a host electronic device (e.g., operating as part of a hardware virtualization service) that hosts compute resources such as compute instances, and the one or more offload cards 870A or 870B execute a virtualization manager that can manage compute instances that execute on the host electronic device. As an example, in some examples the offload card(s) 870A or 870B can perform compute instance management operations, such as pausing and/or un-pausing compute instances, launching and/or terminating compute instances, performing memory transfer/copying operations, etc. These management operations can, in some examples, be performed by the offload card(s) 870A or 870B in coordination with a hypervisor (e.g., upon a request from a hypervisor) that is executed by the other processors 810A-810N of the computing device 800. However, in some examples the virtualization manager implemented by the offload card(s) 870A or 870B can accommodate requests from other entities (e.g., from compute instances themselves), and can not coordinate with (or service) any separate hypervisor.

In some examples, the system memory 820 can be one example of a computer-accessible medium configured to store program instructions and data as described above. However, in other examples, program instructions and/or data can be received, sent, or stored upon different types of computer-accessible media. Generally speaking, a computer-accessible medium can include any non-transitory storage media or memory media such as magnetic or optical media, e.g., disk or DVD/CD coupled to the computing device 800 via the I/O interface 830. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computing device 800 as the system memory 820 or another type of memory. Further, a computer-accessible medium can include transmission media or signals such as electrical, electromagnetic, or digital signals, conveyed via a communication medium such as a network and/or a wireless link, such as can be implemented via the network interface 840.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely-available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, PHP, or TCL, as well as combinations thereof. The server(s) can also include database servers, including without limitation those commercially available from Oracle®, Microsoft®, Sybase®, IBM®, etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth in order to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 718A-718N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method comprising:
hosting a machine learning (ML) model endpoint across a first set of hosts, wherein a router directs model ML inference requests amongst the first set of hosts in a prioritized order based on a hash function;
launching a second set of hosts, hosts in the second set of hosts having a software update not included in hosts of the first set of hosts;
aggregating, from host usage data provided by cache manager applications executing on each host of the first set of hosts, ML model usage data, the ML model usage data including, for a particular ML model, a number of inference requests to the particular ML model and a time that the particular ML model was last requested;
calculating, using the hash function, a per-ML model priority order of hosts in the second set of hosts;
determining, based on the ML model usage data and the per-ML model priority order of hosts in the second set of hosts, a set of ML models to load to a first host in the second set of hosts;
causing the first host to load the set of ML models; and
updating the router to direct ML model inference requests amongst the second set of hosts.

2. The computer-implemented method of claim 1, wherein hosts in the first set of hosts and in the second set of hosts are virtual machines, and wherein the router is a routing application.

3. The computer-implemented method of claim 1, wherein the hash function generates an output within a hash space based on an ML model identifier and a host identifier, and wherein the priority order of hosts for a first ML model is based on an order of hash function outputs within the hash space for an ML model identifier of the first ML model and each host identifier of hosts in the second set of hosts.

4. A computer-implemented method comprising:
aggregating, from host usage data provided from each host of a first set of hosts, machine learning (ML) model usage data, the ML model usage data including, for a particular ML model, a number of inference requests to the particular ML model;
calculating a priority order of hosts in a second set of hosts to service an inference request for the particular ML model;
determining, based on the ML model usage data and the priority order, a set of ML models to load to a particular host in the second set of hosts;
causing the particular host to load the set of ML models; and
updating a router to direct ML model inference requests amongst the second set of hosts.

5. The computer-implemented method of claim 4, wherein hosts in the first set of hosts and in the second set of hosts are virtual machines, and wherein the router is a routing application.

6. The computer-implemented method of claim 4, wherein the priority order is calculated using a hash function, the hash function to generate an output within a hash space based on an ML model identifier and a host identifier, and wherein the priority order of hosts for the particular ML model is based on an order of hash function outputs within the hash space for an ML model identifier of the particular ML model and each host identifier of hosts in the second set of hosts.

7. The computer-implemented method of claim 6, wherein the router uses the hash function to identify a host amongst the second set of hosts to which to route a received ML model inference request.

8. The computer-implemented method of claim 4, wherein each host in the first set of hosts executes a cache manager application to load ML models (1) from a network storage location to a host storage location and (2) from the host storage location to a memory of the host associated with an environment to execute a ML model inference, and further comprising requesting host usage data from the cache manager applications of the first set of hosts.

9. The computer-implemented method of claim 8, wherein the environment to execute the ML model inference is a container.

10. The computer-implemented method of claim 8, wherein a cache manager application of the particular host loads the set of ML models from the network storage location to a memory of the particular host associated with an environment to execute the set of ML models.

11. The computer-implemented method of claim 4, wherein the first set of hosts are part of an ML model hosting endpoint before the router update and the second set of hosts form the ML model hosting endpoint after the router update, and further comprising receiving a request to apply a software update to at least one of the ML model hosting endpoint or a host in the first set of hosts.

12. The computer-implemented method of claim 4, wherein after updating the router, the router no longer directs ML model inference requests to the first set of hosts.

13. A system comprising:
a first one or more computing devices to implement a router in a multi-tenant provider network; and
a second one or more computing devices to implement a machine learning (ML) model hosting service in the multi-tenant provider network, the ML model hosting service including instructions that upon execution cause the ML model hosting service to:
aggregate, from host usage data provided from each host of a first set of hosts, ML model usage data, the ML model usage data including, for a particular ML model, a number of inference requests to the particular ML model;
calculate a priority order of hosts in a second set of hosts to service an inference request for the particular ML model;
determine, based on the ML model usage data and the priority order, a set of ML models to load to a particular host in the second set of hosts;
cause the particular host to load the set of ML models; and
update the router to direct ML model inference requests amongst the second set of hosts.

14. The system of claim 13, wherein hosts in the first set of hosts and in the second set of hosts are virtual machines, and wherein the router is a routing application.

15. The system of claim 13, wherein the priority order is calculated using a hash function, the hash function to generate an output within a hash space based on an ML model identifier and a host identifier, and wherein the priority order of hosts for the particular ML model is based on an order of hash function outputs within the hash space for an ML model identifier of the particular ML model and each host identifier of hosts in the second set of hosts.

16. The system of claim 15, wherein the router uses the hash function to identify a host amongst the second set of hosts to which to route a received ML model inference request.

17. The system of claim 13, wherein each host in the first set of hosts executes a cache manager application to load ML models (1) from a network storage location to a host storage location and (2) from the host storage location to a memory of the host associated with an environment to execute a ML model inference, and further comprising requesting host usage data from the cache manager applications of the first set of hosts.

18. The system of claim 17, wherein a cache manager application of the particular host loads the set of ML models from the network storage location to a memory of the particular host associated with an environment to execute the set of ML models.

19. The system of claim 13, wherein the first set of hosts are part of an ML model hosting endpoint before the router update and the second set of hosts form the ML model hosting endpoint after the router update, and further comprising receiving a request to apply a software update to at least one of the ML model hosting endpoint or a host in the first set of hosts.

20. The system of claim 13, wherein after updating the router, the router no longer directs ML model inference requests to the first set of hosts.
